(19) United States
(12) Patent Application Publication
(10) Pub. No.: US 2013/0082100 A1
(43) Pub. Date: Apr. 4, 2013

(54) System and Method for Processing Barcodes in Electronic Data Communications

(71) Applicants: Stavros Stavrou, Kitchener (CA); Patricia Luengamornsuk, Kitchener (CA)

(72) Inventors: Stavros Stavrou, Kitchener (CA); Patricia Luengamornsuk, Kitchener (CA)

(73) Assignee: Research In Motion Limited, Waterloo, ON (CA)

(21) Appl. No.: 13/634,223

(22) PCT Filed: Aug. 8, 2011
(86) PCT No.: PCT/CA2011/000893

§ 371 Date: Sep. 11, 2012

(51) Int. Cl. G06F 17/00

(52) U.S. Cl. CPC G06F 17/00
USPC 235/375

(57) ABSTRACT

A system and method is provided for electronically reading and analyzing a barcode stored in electronic form. A barcode processing module comprising a barcode detection sub-module that detects the presence of an electronic barcode in electronic form and a barcode analysis module that analyzes the electronically-stored barcode is provided. The barcode processing module may exist on a server, on an electronic device or on both. The barcode may store information or computer executable instructions. If computer executable instructions are provided, the computer executable instructions may be executed by the server, an electronic device or any combination thereof.

### TECHNICAL FIELD

The following relates to a system and method for processing barcodes in electronic data communications.

### BACKGROUND

A barcode is a machine readable graphical representation of data. In commerce, barcodes may be printed on an item and can be used to identify the item, e.g. when the item is being shipped or sold. Barcodes rely on an ordered region of high and low reflectance that can be read and converted to digital information.

One example of a barcode use is in universal product codes (UPC's). UPC barcodes are widely used to identify items in merchant point of sale (POS) systems. UPC barcodes may be printed on items or on labels which are placed on items and are scanned by a specialized scanner at the POS. The scanner converts the graphical representation of data that is provided by the barcode to a digital identifier, represented by, typically, a value. This value can then be compared to a lookup table to determine information about the product such as pricing, expiry dates, the level of stock remaining on shelves, and other information relevant to the merchant.

More recently, barcodes have been used to provide a link to information related to an item. Typically a barcode is placed in the vicinity of an item and when information about the item is desired, the barcode may be scanned by e.g. a mobile device including a barcode scanner or a digital camera. For example, a billboard advertisement for a film may include a barcode which may be scanned by users if they desire information about the film or information relating to when and where the film can be seen.

Users may also display a barcode on a mobile device for another user to scan. This may be used to transfer contact information from a first mobile device to a second mobile device without having to create a physical or wireless connection between devices.

### BRIEF DESCRIPTION OF THE DRAWINGS

Embodiments will now be described by way of example only with reference to the appended drawings wherein:

FIG. 1 is a schematic diagram illustrating an example of a system in which data items are pushed from a host system to a mobile device.

FIG. 2 is a block diagram of an example embodiment of a mobile device.

FIG. 3 is a block diagram illustrating examples of the other software applications and components shown in FIG. 2.

FIG. 4 is an example representation of a QR code.

FIG. 5 is an example flow diagram illustrating computer executable instructions for a process for determining whether or not a message contains a barcode.

FIG. 6 is an example flow diagram illustrating computer executable instructions for a process for performing instructions associated with a barcode.

FIG. 7 is an example flow diagram illustrating computer executable instructions for a process for retrieving instructions associated with a barcode from a database.

FIG. 8 is an example flow diagram illustrating computer executable instructions for a server to detect a barcode in an electronic message, analyze the barcode and provide information associated with the barcode to a mobile device.

FIG. 9 is an example flow diagram illustrating computer executable instructions for a server to detect a barcode in an electronic message, analyze the barcode and perform instructions associated with the barcode.

FIG. 10 is an example flow diagram illustrating computer executable instructions for a server to detect a barcode in an electronic message, analyze the barcode, use information deciphered from the barcode to retrieve instructions from a database and perform the instructions associated with the barcode.

FIG. 11 is an example diagram showing a user selectable option for a mobile device to analyze an electronically stored barcode.

FIG. 12 is an example diagram showing a user selectable option for a mobile device to install a program associated with the barcode.

FIG. 13 is an example flow diagram illustrating computer executable instructions for a server to retrieve information or instructions associated with the barcode from a server and perform the instructions or deliver the content associated with the barcode to one or more mobile devices.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

Barcodes have recently found use in transferring data to electronic devices (also referred to herein as devices), such as mobile devices (i.e. electronic devices enabled for wireless communication). For example, mobile devices including cameras can convert a visual representation of a barcode on a tangible medium and convert the barcode to digital information. It is also possible to transfer information from a first electronic device having a display to a second electronic device having an image capture or scanning module, for example, a camera. This is accomplished by displaying a barcode on the first device and capturing the barcode with the second device using a scanning photography capability. Using this method, information can be transferred between a first device that is capable of displaying a barcode and a second device capable of capturing and analyzing the barcode. Further, because only a visual representation of data is being transferred, the information could be transferred between devices using, for example, different operating systems and requires no physical connection between the devices. A single barcode may be scanned multiple times and by multiple devices.

In practice, barcodes may be applied to advertising billboards and pamphlets. Applying a barcode to an advertisement allows the user of the mobile device to capture the barcode using the device's onboard camera and the mobile device can subsequently process the image to detect a barcode and analyze the barcode. The information encoded in the barcode could include, for example, a uniform resource locator (URL), contact information, a link to download an item from a database, permission, an identifying number or a set of instructions. Once the mobile device deciphers the barcode, the information can be used, for example, to open a link to a particular webpage, to add a new contact to an electronic address book, or to retrieve and execute a file stored on a database and accessible through a network. A single barcode could also provide a link to a file on a database and allow the device that has extracted the barcode information to retrieve the file from the database. The barcode information may also be attached to information specific to the device, for example, that the device is a mobile device running a particular operating system and displaying text in the English language, to deliver the file in the correct format and language.

Despite the advantages of barcodes, in some scenarios, it can be disadvantageous to require a device to scan or photograph a barcode each time the information is desired. As mentioned above, the transfer of information using a barcode to transfer information has several advantages that are unrelated to scanning a physical representation of data. In particular, as barcodes may be used to, e.g., add new contacts on devices, it may be useful to send a barcode via e-mail. Currently, when barcodes are received in a message such as an e-mail, a first electronic device typically displays the barcode for a second electronic device to capture the barcode and to decipher the barcode. When the device receiving the message including a barcode is the device that wishes to process the barcode, currently a second device is needed to display the barcode for the device to scan or photograph. For example, this may be performed when a user receives a barcode in an e-mail message. The user opens the e-mail on a personal computer such that the visual representation including the barcode, which can stored as an image file, is displayed on the personal computer's display. The user then photographs the barcode using the onboard camera on the mobile device. The barcode is subsequently analyzed and the electronic device may perform one or more functions associated with the barcode. Requiring the user to first display the barcode on a display of the other device and then manually take the image can be cumbersome, time consuming, and would require access to the other device having a display.

For example, in such an example scenario, the user would not be able to receive and decipher the barcode on an electronic device that does not have an onboard camera, or does not have access to a camera or other barcode-compatible scanner. Also, if the user does not have access to a device upon which the barcode may be displayed, the user will not be able to decipher the information encoded in the barcode. Moreover, even if the user does wish to open the barcode on an electronic device equipped with an onboard camera and the user does have access to a first electronic device capable of displaying a barcode, the time and effort required to load a barcode on the first electronic device and photograph the display of the first electronic device can diminish the advantages of using a barcode.

To facilitate the distribution of information originating in a barcode, it may be useful to decipher the encoded information prior to delivery to the mobile device. For example, if an electronic message sent to a user contains contact information, it may be useful to have this contact information distributed to several devices, for example, a mobile device and a personal computer. The barcode may also contain instructions that can be executed by an electronic device or instructions that may be executed by a server, for example, instructions to install an application, in which case the server may retrieve the application from a database and deliver the application to several electronic devices.

Therefore, if a user receives a barcode electronically, for example, through e-mail, a system and method to recognize the presence of a barcode in the electronic message and to decipher the electronic barcode is useful. Hence, a system and method to detect and decipher an electronically stored barcode obviating the need for a second electronic device is provided. A system and method for enabling a server to detect and decipher a barcode is also provided. The server may further perform instructions associated with the barcode or may send information associated with the barcode to one or more electronic devices.

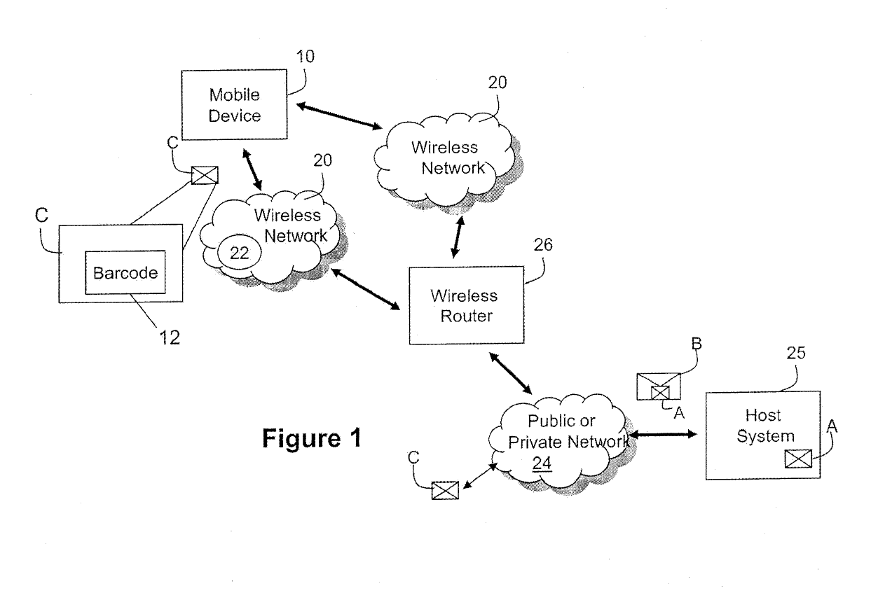

FIG. 1 is an example embodiment of a system configured for facilitating the redirection of user data items (such as message A or C) from a corporate enterprise computer system (host system) 25 to the user's mobile device 10 via a wireless router 26. Depending on the functionality provided by the mobile device 10, in various example embodiments, mobile device 10 may be a data communication device, a multiple-mode communication device configured for both data and voice communication, a smartphone, a tablet computer, a mobile telephone or a PDA (personal digital assistant) enabled for wireless communication, or a computer system with a wireless modem. The host system 25 and wireless router 26 are examples of network components or server entities that may be operable to detect and decipher a barcode in an electronic message. It can be appreciated that the system shown in FIG. 1 is for illustrative purposes only and the principles discussed below can be applied to any system including at least one electronic device. Also shown by way of example only is a barcode 12 included in a data item C (enlarged sub-view shown in FIG. 1). The data item C in this example embodiment may include, for example, an email message.

The wireless router 26, in this example embodiment, provides wireless connectivity functionality as it acts to both abstract most of the wireless network's 20 complexities, and it also implements features necessary to support pushing data to the mobile device 10. Although not shown, a plurality of mobile devices 10 may access data from the host system 25. In this example, message A in FIG. 1 represents an internal message sent from, e.g. a desktop computer (not shown) within the host system 25, to any number of server computers in the corporate network (e.g. LAN), which may, in general, include a database server, a calendar server, an E-mail server or a voice-mail server.

Message C in FIG. 1 represents an external message from a sender that is not directly connected to the host system 25, such as the user's mobile device 10, some other user's mobile device (not shown), or any user connected to the public or private network 24 (e.g. the Internet). Message C could be e-mail, voice-mail, calendar information, database updates, web-page updates or could even represent a command message from the user's mobile device 10 to the host system 25. The host system 25 may include, along with the typical communication links, hardware and software associated with a corporate enterprise computer network system, one or more wireless mobility agents, a TCP/IP connection, a collection of data stores, (for example a data store for e-mail could be an off-the-shelf mail server like Microsoft Exchange® Server or Lotus Notes® Server), all within and behind a corporate firewall.

The mobile device 10 may be adapted for communication within wireless network 20 via wireless links, as required by each wireless network 20 being used. As an illustrative example of the operation for a wireless router 26 shown in FIG. 1, consider a data item A, repackaged in outer envelope B (the packaged data item A now referred to as “data item (A)”) and sent to the mobile device 10 from an Application Service Provider (ASP) in the host system 25. Within the ASP is a computer program, similar to a wireless mobility agent, running on any computer in the ASP's environment that is sending requested data items from a data store to a mobile device 10. The mobile-destined data item (A) is routed through the network 24, and through the wireless router's 26 firewall protecting the wireless router 26 (not shown).

Although the above describes the host system 25 as being used within a corporate enterprise network environment, this is just one example embodiment of one type of host service that offers push-based messages for a handheld wireless device that is capable of notifying and presenting the data to the user in real-time at the mobile device when data arrives at the host system.

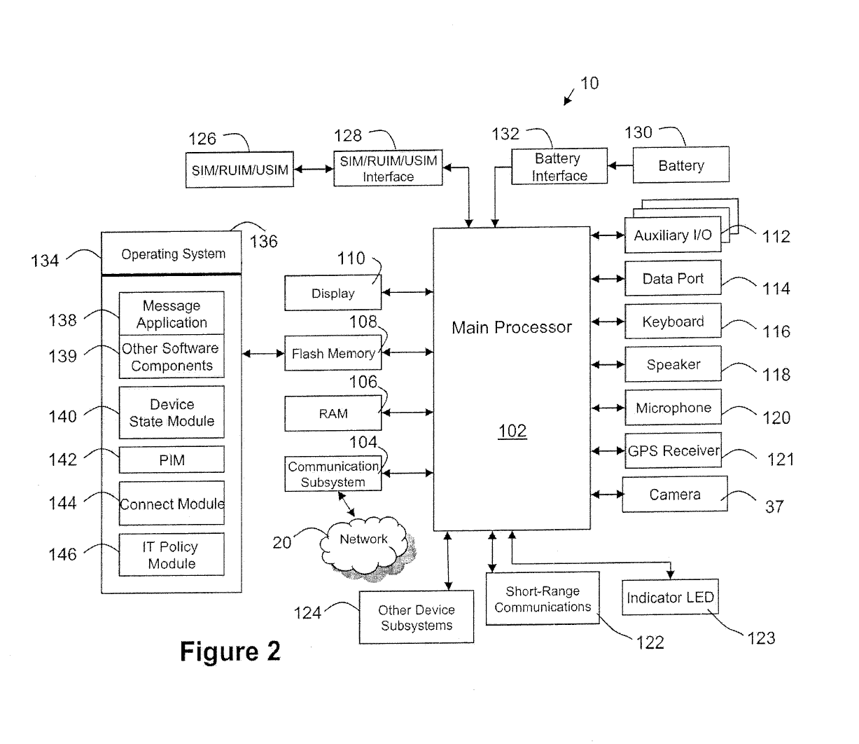

By offering a wireless router 26 (sometimes referred to as a “relay”, “message server”, “data redirector”, etc.), there are a number of major advantages to both the host system 25 and the wireless network 20. The host system 25 in general runs a host service that is considered to be any computer program that is running on one or more computer systems. The host service is said to be running on a host system 25, and one host system 25 can support any number of host services. A host service may or may not be aware of the fact that information is being channelled to mobile devices 10. For example an e-mail or message program 138 (see FIG. 2A) might be receiving and processing e-mail while an associated program (e.g. an e-mail wireless mobility agent) is also monitoring the mailbox for the user and forwarding or pushing the same e-mail to a wireless device 10. A host service might also be modified to prepared and exchange information with mobile devices 10 via the wireless router 26, like customer relationship management software. In a third example, there might be a common access to a range of host services. For example a mobility agent might offer a Wireless Access Protocol (WAP) connection to several databases.

Although the example system is described as operating in a two-way communications mode, certain aspects of the system could be used in a “one and one-half” or acknowledgment paging environment, or even with a one-way paging system. In such limited data messaging environments, the wireless router 26 still could abstract the mobile device 10 and wireless network 20, offer push services to standard web-based server systems and allow a host service in a host system 25 to reach the mobile device 10 in many countries.

The host system 25 shown herein can have many methods when establishing a communication link to the wireless router 26. For one skilled in the art of data communications the host system 25 could use connection protocols like TCP/IP, X.25, Frame Relay, ISDN, ATM or many other protocols to establish a point-to-point connection. Over this connection there are several tunneling methods available to package and send the data, some of these include: HTTP/HTML, HTTP/XML, HTTP/Proprietary, FTP, SMTP or some other proprietary data exchange protocol. The type of host systems 25 that might employ the wireless router 26 to perform push could include: field service applications, e-mail services, stock quote services, banking services, stock trading services, field sales applications, advertising messages and many others. This wireless network 20 abstraction is made possible by the wireless router 26, which implements this routing and push functionality. The type of user-selected data items being exchanged by the host could include: E-mail messages, calendar events, meeting notifications, address entries, journal entries, personal alerts, alarms, warnings, stock quotes, news bulletins, bank account transactions, field service updates, stock trades, heart-monitoring information, vending machine stock levels, meter reading data, GPS data, etc., but could, alternatively, include any other type of message that is transmitted to the host system 25, or that the host system 25 acquires through the use of intelligent agents, such as data that is received after the host system 25 initiates a search of a database or a website or a bulletin board.

The wireless router 26 provides a range of services to make creating a push-based host service possible. These networks may include: (1) the Code Division Multiple Access (CDMA) network, (2) the Groupe Special Mobile or the Global System for Mobile Communications (GSM) and the General Packet Radio Service (GPRS), and (3) the existing and upcoming third-generation (3G) and fourth generation (4G) networks like EDGE, UMTS and HSDPA, LTE, Wi-Max etc. Some older examples of data-centric networks include, but are not limited to: (1) the Mobitex Radio Network (“Mobitex”) and (2) the DataTAC Radio Network (“DataTAC”).

To be effective in providing push services for host systems 25, the wireless router 26 may implement a set of defined functions. It can be appreciated that one could select many different hardware configurations for the wireless router 26; however, many of the same or similar set of features would likely be present in the different configurations.

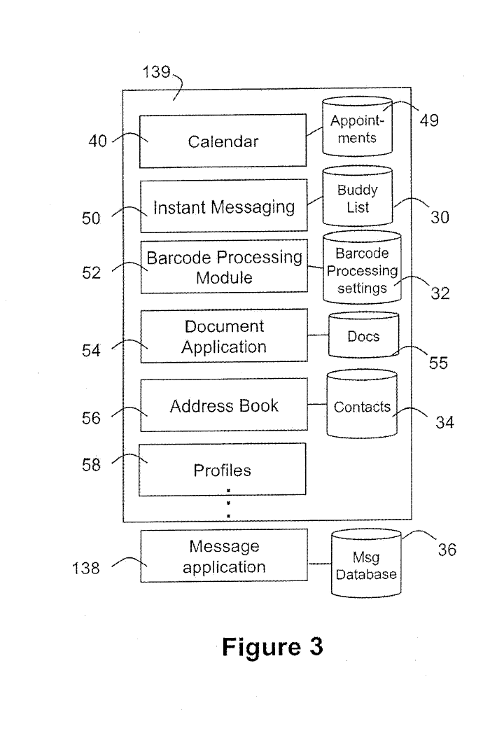

An example embodiment of a configuration for a mobile device 10 is illustrated in FIGS. 2 and 3. Referring first to FIG. 2, the mobile device 10 includes a number of components such as a main processor 102 that controls the overall operation of the mobile device 10. Communication functions, including data and voice communications, are performed through a communication subsystem 104. The communication subsystem 104 receives messages from and sends messages to a wireless network 20. In this example embodiment of the mobile device 10, the communication subsystem 104 is configured in accordance with the GSM and GPRS standards, which are used worldwide. Other communication configurations that are equally applicable are the 3G and 4G networks discussed above. New standards are still being defined, but it is believed that they will have similarities to the network behaviour described herein, and it will also be understood by persons skilled in the art that the example embodiments described herein are intended to use any other suitable standards that are developed in the future. The wireless link connecting the communication subsystem 104 with the wireless network 20 represents one or more different Radio Frequency (RF) channels, operating according to defined protocols specified for GSM/GPRS communications.

The main processor 102 also interacts with additional subsystems such as a Random Access Memory (RAM) 106, a flash memory 108, a display 110, an auxiliary input/output (I/O) subsystem 112, a data port 114, a keyboard 116, an accelerometer (not shown in FIG. 2), a gyroscope (not shown in FIG. 2), a speaker 118, a microphone 120, a GPS receiver 121, short-range communications 122, an indicator light emitting diode (LED) 123, and other device subsystems 124. As will be discussed below, the short-range communications 122 can implement any suitable or useful device-to-device or peer-to-peer communications protocol capable of communicating at a relatively short range, e.g. directly from one device to another. Examples include Bluetooth®, ad-hoc WiFi, infrared, or any “long-range” protocol re-configured to utilize available short-range components. It will therefore be appreciated that short-range communications 122 may represent any hardware, software or combination of both that enable a communication protocol to be implemented between devices or entities in a short range scenario, such protocol being standard or proprietary.

Some of the subsystems of the mobile device 10 perform communication-related functions, whereas other subsystems may provide “resident” or on-device functions. By way of example, the display 110 and the keyboard 116 may be used for both communication-related functions, such as entering a text message for transmission over the network 20, and device-resident functions such as a calculator or task list. The mobile device 10 further includes a camera 37, or other barcode scanning equipment. The camera 37 can be used to visually capture a barcode 12 from a printed medium or a barcode 12 from the display of another electronic device.

The mobile device 10 can send and receive communication signals over the wireless network 20 after required network registration or activation procedures have been completed. Network access is associated with a subscriber or user of the mobile device 10. To identify a subscriber, the mobile device 10 may use a subscriber module component or “smart card” 126, such as a Subscriber Identity Module (SIM), a Removable User Identity Module (RUIM) and a Universal Subscriber Identity Module (USIM). In the example shown, a SIM/RUIM/USIM 126 is to be inserted into a SIM/RUIM/USIM interface 128 in order to communicate with a network. Without the component 126, the mobile device 10 is not fully operational for communication with the wireless network 20. Once the SIM/RUIM/USIM 126 is inserted into the SIM/RUIM/USIM interface 128, it is coupled to the main processor 102.

The mobile device 10 is typically a battery-powered device and in this example includes a battery interface 132 for receiving one or more rechargeable batteries 130. In at least some example embodiments, the battery 130 can be a smart battery with an embedded microprocessor. The battery interface 132 is coupled to a regulator (not shown), which assists the battery 130 in providing power V+ to the mobile device 10. Although current technology makes use of a battery, future technologies such as micro fuel cells may provide the power to the mobile device 10.

The mobile device 10 also includes an operating system 134 and software components 136 to 146 which are described in more detail below. The operating system 134 and the software components 136 to 146 that are executed by the main processor 102 are typically stored in a persistent store such as the flash memory 108, which may alternatively be a read-only memory (ROM) or similar storage element (not shown). Those skilled in the art will appreciate that portions of the operating system 134 and the software components 136 to 146, such as specific device applications, or parts thereof, may be temporarily loaded into a volatile store such as the RAM 106. Other software components can also be included, as is well known to those skilled in the art.

The subset of software applications 136 that control basic device operations, including data and voice communication applications, may be installed on the mobile device 10 during its manufacture. Software applications may include a message application 138, a device state module 140, a Personal Information Manager (PIM) 142, a connect module 144, an IT policy module 146 and an Identity Agent 148. A message application 138 can be any suitable software program that allows a user of the mobile device 10 to send and receive electronic messages, wherein messages are typically stored in the flash memory 108 of the mobile device 10. A device state module 140 provides persistence, i.e. the device state module 140 ensures that important device data is stored in persistent memory, such as the flash memory 108, so that the data is not lost when the mobile device 10 is turned off or loses power. A PIM 142 includes functionality for organizing and managing data items of interest to the user, such as, but not limited to, e-mail, text messages, instant messages, contacts, calendar events, and voice mails, and may interact with the wireless network 20. A connect module 144 implements the communication protocols that are required for the mobile device 10 to communicate with the wireless infrastructure and any host system 25, such as an enterprise system, that the mobile device 10 is authorized to interface with. An IT policy module 146 receives IT policy data that encodes the IT policy, and may be responsible for organizing and securing rules such as the “Set Maximum Password Attempts” IT policy. An identity agent 148 collects and stores credentials and provides these credentials to other applications running on the operating system 134.

Other types of software applications or components 139 can also be installed on the mobile device 10. These software applications 139 can be pre-installed applications (i.e. other than message application 138) or third party applications, which are added after the manufacture of the mobile device 10. Examples of third party applications include games, calculators, utilities, etc. The additional applications 139 can be loaded onto the mobile device 10 through at least one of the wireless network 20, the auxiliary I/O subsystem 112, the data port 114, the short-range communications subsystem 122, or any other suitable device subsystem 124.

The data port 114 can be any suitable port that enables data communication between the mobile device 10 and another computing device. The data port 114 can be a serial or a parallel port. In some instances, the data port 114 can be a USB port that includes data lines for data transfer and a supply line that can provide a charging current to charge the battery 130 of the mobile device 10.

For voice communications, received signals are output to the speaker 118, and signals for transmission are generated by the microphone 120. Although voice or audio signal output is accomplished primarily through the speaker 118, the display 110 can also be used to provide additional information such as the identity of a calling party, duration of a voice call, or other voice call related information.

For composing data items, such as e-mail messages, for example, a user or subscriber could use a touch-sensitive overlay (not shown) on the display 110 that is part of a touch screen display (not shown), in addition to possibly the auxiliary I/O subsystem 112. The auxiliary I/O subsystem 112 may include devices such as: a mouse, track ball, infrared fingerprint detector, or a roller wheel with dynamic button pressing capability. A composed item may be transmitted over the wireless network 20 through the communication subsystem 104.

FIG. 3 shows an example of the other software applications and components 139 that may be stored on and used with the mobile device 10. Only examples are shown in FIG. 3 and such examples are not to be considered exhaustive. In this example, a calendar application 40, instant messaging application 50, a barcode processing module 52, a document viewing or editing application 54, an address book 56 and a profiles application 58 are shown to illustrate the various features that may be provided by the mobile device 10. These applications can access information stored on the mobile device, e.g. appointments 49, buddy list 30, barcode processing settings 32, documents (docs) 55, and contacts 34. Also shown in FIG. 3 is the message application 138, which in the following may also be referred to as an email application 138 for clarity and stores or otherwise has access to a message database 36 for storing incoming and outgoing messages as well as those stored in various folders. It will be appreciated that the various applications may operate independently or may utilize features of other applications. For example, the email application 138 may use the address book 56 for contact details obtained from a list of contacts 34.

The barcode processing module 52 can be used to detect electronic barcodes 12 and analyze electronic barcodes 12. For example, the barcode processing module 52 may operate on all incoming e-mail addresses that include an image file. The barcode processing module 52 may analyze the image file to determine whether the image file includes features consistent with those of a barcode 12. If the image file does include features consistent with a barcode 12, the barcode processing module 52 could then analyze the barcode 12 and perform instructions associated with the barcode 12. The barcode processing module 52 may be enabled or disabled by adjusting the barcode processing settings 32. For example, the barcode processing module 52 may be enabled to scan all incoming electronic messages for images files and analyze the image files to determine whether the image files contain a barcode 12. The barcode processing module 52 may be set to automatically decipher the barcode 12 or may be set to request user permission to decipher the information contained within the barcode 12, as is further described below. Alternatively, to conserve system resources and/or to prevent the system from accessing barcode information that may not be useful to the user of the mobile device 10, the barcode processing module 52 may be disabled entirely. The barcode processing module 52 may also be configured to detect barcodes 12 of only one type, or of several types.

The barcode processing module 52 can be used with the document viewer and editor 54 and other applications (e.g. address book 56, profiles 58, internet browser, and calendar 48). For example, the barcode processing module 52 can access image files on web pages to decipher barcodes 52 present in online pamphlets or those displayed by a remote party during a video conference session.

It will be appreciated that any example application or module described herein may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data, except transitory propagating signals per se. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the mobile device 10 or any other communication device, or accessible or connectable thereto. Any application or module herein described may be implemented using computer readable/executable instructions that may be stored or otherwise held by such computer readable media.

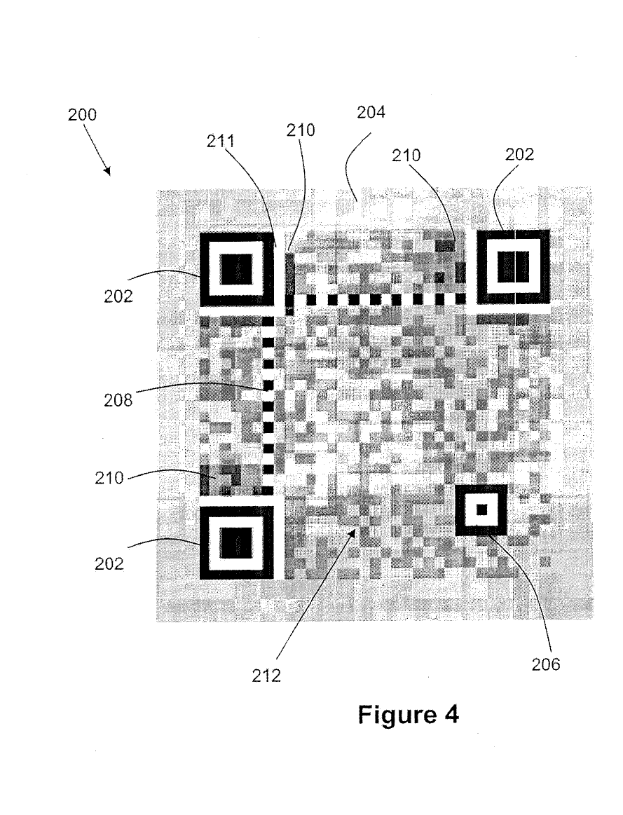

Various barcodes 12 may be detected and analyzed by the barcode processing module 52 in the mobile device 10. One example of a two dimensional barcode 12 currently used to transfer information to mobile devices from printed media and to transfer information, including contact information, between mobile devices is the quick response code, also known as a “OR” code. Turning to FIG. 4, a representative QR code, hereinafter referred to using reference numeral 200. Although a QR code 200 is used in this example, any barcode 12, including one-dimensional barcodes 12, could be used according to the principles discussed herein. For example, the barcode 12 could be a universal product code (UPC) type barcode 12, an Aztec type barcode 12 or a datamatrix type barcode 12, etc.

A QR code 200 is characterized by several features that make this type of barcode 12 a good choice for fast detection and analysis. This has made QR codes 200 popular with mobile devices 10, particularly when the QR code 200 is being scanned using a mobile device 10 including an onboard camera 37. A QR code 200 is built from a grid of data cells and typically includes seven (7) components: the position-detection blocks 202, a quiet zone 204, an alignment block 206, a timing pattern 208, a format information section 210, separators 211, and the data area 212. The position detection blocks 202 are located proximal to three of the four corners of the QR code 200. The position detection blocks 202 are easily distinguishable and may be the first feature to be detected by a barcode reader, or when analyzed electronically, the barcode processing module 52. The position detection blocks 202 also serve to calculate the angle at which the QR code 200 is facing relative to the camera 37 or the orientation of the image file. The quiet zone 204 includes a margin on the outer perimeter of the QR code 200 that allows the QR code 200 to be distinguished from its background. For example, if the QR code 200 is located within a larger image, the quiet zone 204 serves to outline and isolate the QR code 200 from the background. The alignment pattern 206 may be used to compensate for any local distortion of the QR code 200 image by adjusting for the position of each data cell. The timing pattern 208 includes broken line borders placed between the position detection blocks 202 and allow the relative position of the center of each data cell to be modified, if required, to compensate for distortion. The format information section 210 provides information relating to the version of the QR code 200 that is being represented as well as information regarding the error correction characteristics of the QR code 200. The separators 211 distinguish the format information sections from the position detection blocks 202. Importantly, the data area 212 is where the useful information, for example, a URL, or an e-mail address is stored.

The barcode processing module 52 may detect the barcode 12 by using the presence of any of these features or a combination of these features. In one example embodiment, the barcode processing module 52 may detect the position detection blocks 202 of the QR code 200 to determine whether a barcode 12 is contained in an electronic image file. The barcode processing module 52 may be configured to detect only QR codes 200 rather than detect all barcodes 12. If the barcode processing module 52 is configured to detect QR codes 200, the position detection blocks 202 may serve as a distinguishing feature such that in the absence of position detection blocks 202, the barcode processing module 52 does not recognize the barcode 12 as one that should be analyzed.

The barcode processing module 52 may operate using various configurations to extract information from barcodes 12 that are persistently or temporarily electronically stored on the mobile device 10. In one example embodiment, the barcode processing module 52 may be configured such that at any time that an image file is opened on the display 110 of the mobile device 10, the barcode processing module 52 determines whether there is a barcode 12 present in the image file, and if so, may proceed to analyze the barcode 12. In another embodiment, the sender of the barcode 12 may include a tag, flag or other digital indicator associated with the barcode 12, that indicates to the barcode processing module 52 that a barcode 12 within the image file is to be deciphered. In another example embodiment, when the user recognizes an electronically stored barcode 12, for example in an e-mail message, the user may click on the barcode 12 to decipher the barcode 12. The user may then be further prompted to act based on the information extracted from the barcode 12. For example, the barcode 12 may provide instructions to download a file, in which case, the user would confirm that the file should be downloaded.

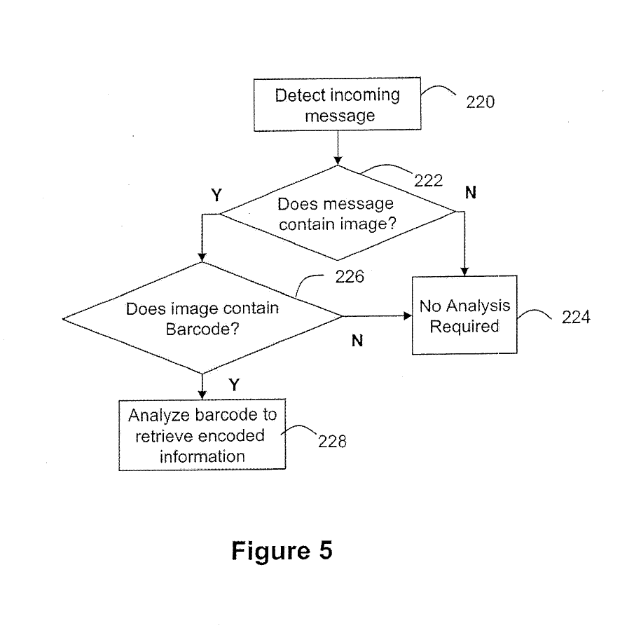

Turning to FIG. 5, an example of a set of computer executable instructions is shown that may be executed for determining whether an image file contains a barcode 12. At 220, the barcode processing module 52 detects an incoming message. The barcode processing module 52 then determines at 222 whether the incoming message contains an image, for example in the form of an attachment. If the incoming message does not contain an image file, no further analysis is required at 224. However, if the message does contain an image file, the image file is further analyzed to determine whether the image contains a barcode 12 at 226. For example, if the barcode processing module 52 is configured to recognize and analyze only QR codes 200, the barcode processing module 52 may search through the image using, for example, image analysis techniques, to determine whether the image includes position detection blocks 202. If the image does not include position detection blocks, the image does not include a QR code 200 and no further analysis is required. However, if the image does include position detection blocks 202, the barcode processing module 52 may decide that the image does include a QR code 200. The image processing module 52 may also decide to further analyze the image to determine whether the image includes other features associated with QR codes 200, for example, an alignment pattern 206. The barcode processing module 52 may then proceed at 228 with analyzing the barcode 12 to extract the encoded information.

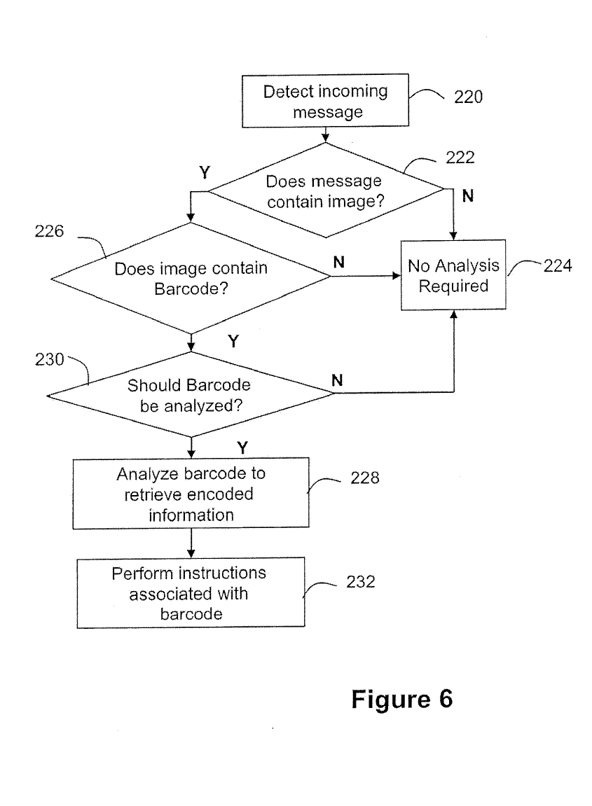

Turning now to FIG. 6, an example of a set of computer executable instructions is shown, similar to the instructions shown in FIG. 5, wherein if at 226 the barcode processing module 52 determines that the image does contain a barcode 12, a further operation is performed to determine whether the barcode 12 should be analyzed. It can be appreciated that it may not be desirable to analyze the barcode 12, as the user may not be interested in the information contained within the barcode 12. It may also be undesirable to analyze a barcode 12 if the user initiates a scan of image files searching for a particular type of barcode 12, for example a QR code 200. It may also be undesirable to analyze a barcode 12 that was part of the background of a photograph. For example, it may be desirable to configure the settings of the barcode processing module 52 such that barcodes 12 that are smaller than a certain percent of the total image size are not analyzed, or similarly, barcodes 12 that are captured at an angle greater than a certain threshold are not analyzed, as it is unlikely that these barcodes 12 were purposely captured. If, at 230, the barcode processing module 52 determines that the barcode 12 should be analyzed, the barcode 12 is analyzed at 228. If the information encoded in the barcode 12 includes a set of instructions, these instructions may be executed at 232. The user (e.g. via a prompt—not shown), or previously-configured settings stored on the mobile device 10, may be consulted prior to execution of the instructions. If the encoded information contains such instructions, the mobile device 10 may further execute those instructions. The barcode processing module 52 may request user permissions in order to proceed with analyzing the barcode 12 to retrieve the encoded information at 228, which may depend on the barcode processing settings 32 of the mobile device 10. The barcode processing module 52 may also request permissions from the mobile device 10, which may exist as default settings or as user defined settings.

Since each barcode 12 contains only a finite amount of data, more than one barcode 12 may be used in some example embodiments to encode an amount of data that is greater than what can be encoded in a single barcode 12. For example, a high density QR code 200 may contain several thousand alphanumeric characters. Although this may be enough space to store a user's contact information or a URL, it may not be enough space to store a detailed set of instructions or many types of files such as image files or sound files. To overcome this, several barcodes 12 could be analyzed and combined. Alternatively, the barcode 12 could provide a link, for example in the form of a URL, or a unique number that could be mapped to a larger file in a database. In such an example embodiment, when the barcode processing module 52 extracts the encoded information from a barcode 12, this information would then be used to retrieve a larger file that includes the information intended to be delivered to the recipient. For example, the larger file may include a more detailed set of instructions, an image file, a sound clip or, more generally, one or more folders containing a plurality of individual electronic files.

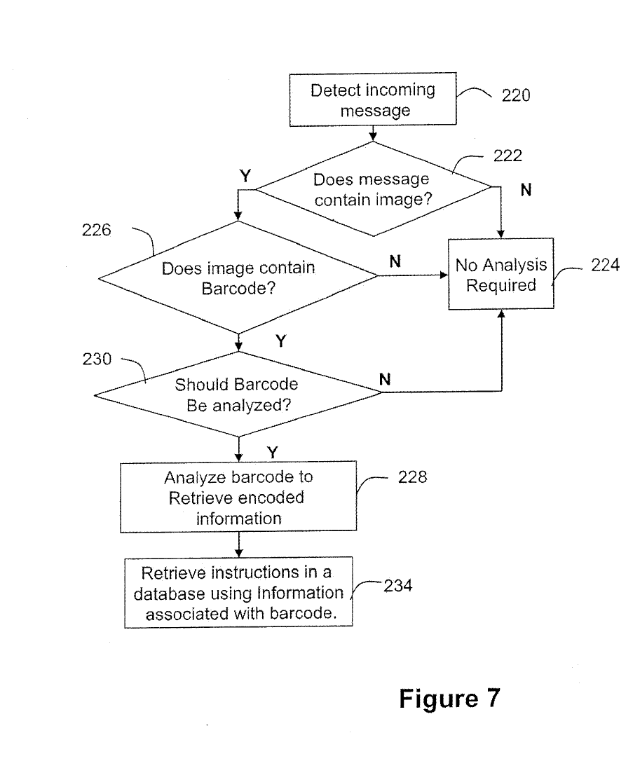

Turning now to FIG. 7, an example of a set of computer executable instructions is shown. In the example embodiment shown in FIG. 7, instead of performing instructions that are contained within a barcode 12 (e.g. at 232 shown in FIG. 6) or associated with a barcode 12, the barcode processing module 52 extracts the barcode information which includes an address or a mapping to a more detailed set of instructions. It can be appreciated that operations 220 through 228 in FIG. 7 are similar to those shown in FIG. 6. After completing operations 220 through 228 as describe above, the mobile device 10 retrieves the detailed set of instructions from a database in its own memory 108, or a database over the network 20 at 234. The mobile device 10 can then execute the instructions retrieved from the database. Similarly, if the barcode information includes an address or a mapping to a file larger than that which could be delivered via a barcode 12, the mobile device 10 can, for example, retrieve the larger file over the network and deliver the contents of the file to the user.

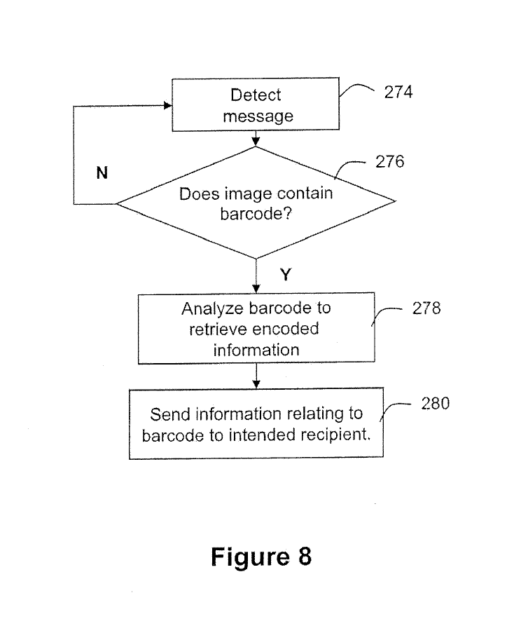

It may sometimes be useful for the barcode 12 to be analyzed outside of the mobile device 10 at a server. For example, if a user receives an e-mail, the host system 25 may detect and analyze the barcode 12 prior to the barcode 12 arriving in the user's inbox. This could reduce the load on resources within the mobile device 10 and may also enable the host system 25 to provide the information across several devices. For example, if the barcode 12 contains contact information, it may be useful to add the contact information to the address book 56 of each of the user's devices. For example, it may be useful to add the contact information to a personal desktop computer, a mobile computer such as a laptop or tablet computer, portable gaming device, and a smart phone. If the host system 25 extracts the information, the contact information could be synchronized with each of these devices. It may also be useful for the host system 25 to install any new applications that may be associated with the barcode 12. The computer executable instructions of FIG. 8 outline a method whereby a message is detected by the server at 274. The message is then analyzed at 276 to determine whether a barcode 12 is present in the message. If a barcode 12 is present in the message, the barcode 12 is analyzed and the encoded information is retrieved from the barcode 12 at 278. The information relating to the barcode 12 may then be sent to the mobile device 10 at 280. This example embodiment is applicable in a system run in the cloud, as information sent to one user may be accessed across a range of devices.

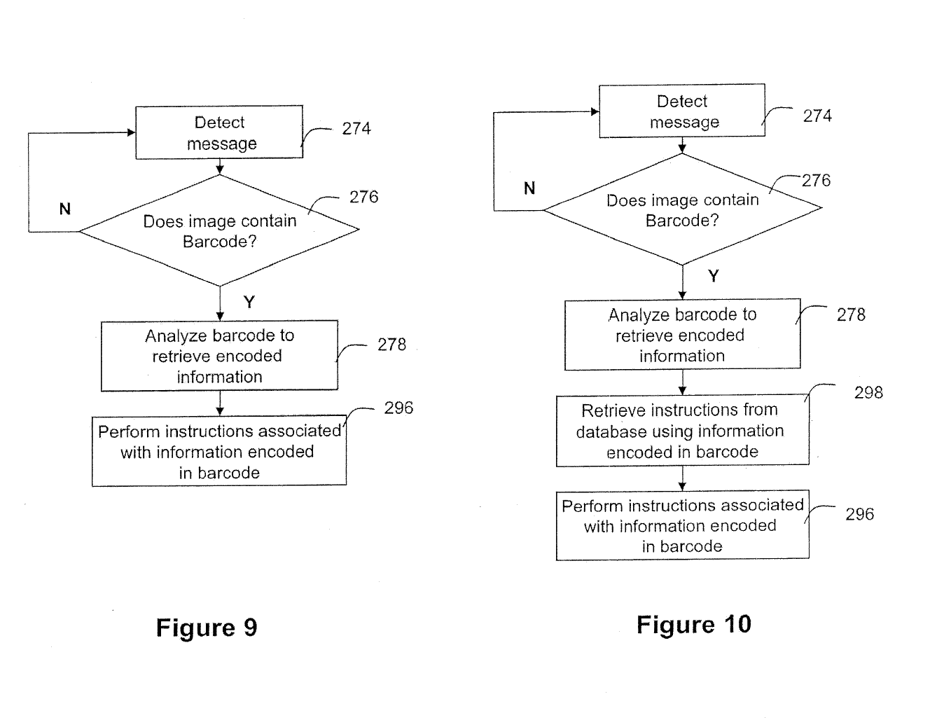

Turning to FIG. 9, computer executable instructions similar to those of FIG. 8 are illustrated, wherein a message is detected by the server at 274. The message is then analyzed at 276 to determine whether a barcode 12 is present in the message. If a barcode 12 is not present in the message, controls returns to 274. If a barcode 12 is present in the message, the barcode 12 is analyzed and the encoded information is retrieved from the barcode 12 at 278, however, instead of sending the information associated with the barcode 12 to one or more mobile devices 10, the server performs instructions associated with the information encoded within the barcode 12 at 296. These instructions may include, for example, instructions for communicating with one or more mobile devices, performing status checks, or installing applications associated with the barcode 12.

The computer executable instructions of FIG. 10 are similar to those of FIG. 9 wherein a message is detected by the server at 274. The message is analyzed at 276 to determine whether a barcode 12 is present in the message. If a barcode 12 is present in the message, the barcode 12 is analyzed and the encoded information is retrieved from the barcode 12 at 278. The information extracted from the barcode 12 is then used by the server to access a database of instructions and to retrieve the instructions at 298. The database may be connected to the server or may be accessed through a network. Once the instructions are retrieved from the database, they may be executed at 296.

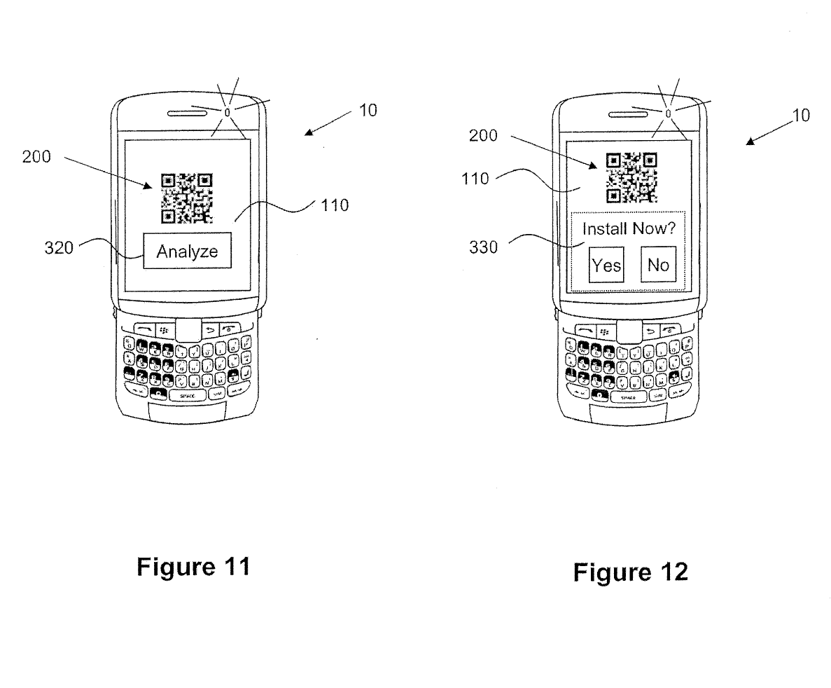

In some example embodiments, it may be useful for the barcode processing module 52 to be activated only upon detecting an input from a user. For example, if the user is browsing a promotional flyer on the Internet, it may not be desirable to analyze each barcode 12 that may be included in the promotional flyer. An example diagram of an option to activate the barcode processing module 52 only when the user explicitly requests a barcode 12 to be analyzed, is shown in FIG. 11. For example, the user may click or tap a barcode 12 and a menu may appear in which the user may click to analyze the barcode 12. Alternatively, as shown in FIG. 11, the barcode processing module 52 may recognize the QR code 200 shown on the display 110 and provide an option 320 for the user to analyze the barcodes 12. If the user clicks the analyze button 320, the QR code 200 will be analyzed. Otherwise, the barcode 12 appears as a typical image file. FIG. 12 shows the mobile device of FIG. 11 after the user has selected to analyze the QR code 200. The user is then given the option to perform the function or retrieve a file specified by the QR code 200 using an option box 330. If the user wishes to perform the action associated with the QR code 200, the user accepts, otherwise, no further steps are taken. As shown in FIG. 12, the option 330 may relate to installing an application that can be retrieved from a database over the network 20. In this embodiment, the barcode 12 may contain, for example, instructions about from where the application can be retrieved or downloaded.

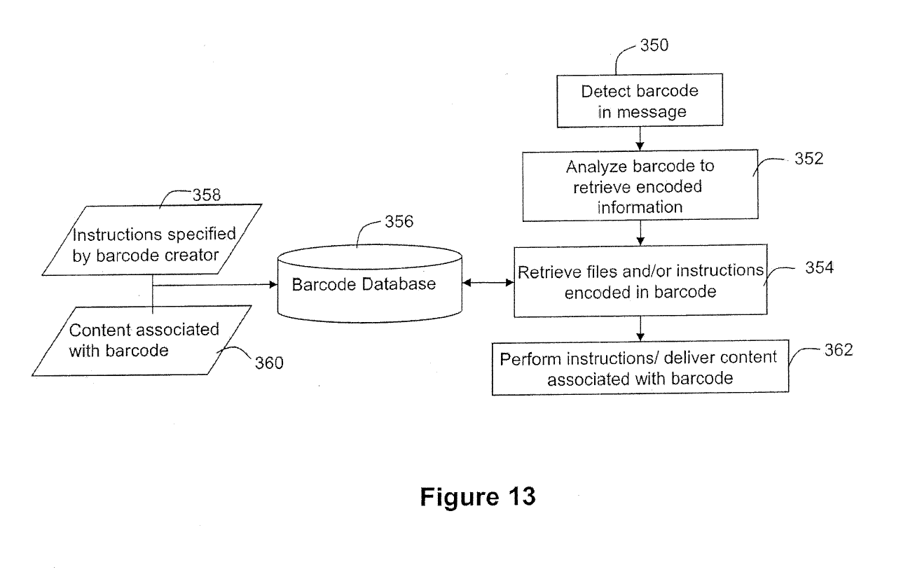

Turning to FIG. 13, an example configuration of a system is shown, wherein a barcode 12 is detected in a message by a server at 350. At 352, the server may decipher the barcode 12 to retrieve the information encoded therein. Once the barcode 12 has been deciphered to provide information (e.g. a uniform resource locator (URL), a link to download an item from a database, permission, an identifying number, or a set of instructions) previous encoded within the barcode 12, further instructions 358 and/or content 360 may be retrieved at 354 from a barcode database 356. The barcode database 356 may contain, for example, a video file. The barcode database 356 may also provide the server with a video file upon request. The barcode database 356 may also contain information specific to a particular person that is limited to only those entities who have received barcode 12. For example, if the information encoded from barcode 12 contains a link to information about a contact (such as contact information, a resume, and a photograph), this information may be retrieved from barcode database 356 and distributed to only those entities who have received the barcode 12. The information may be uploaded to the barcode database 356 manually by a user or may be uploaded by another server. The barcode database 356 may contain, for example, instructions specified by the barcode creator 358, for example, instructions to download and install an application. The barcode database 356 may also contain content 360 associated with a barcode 12, such as media files or documents. Once the server has retrieved the content associated with the barcode 12, the server can perform the functions retrieved from the barcode database 356 and/or deliver content associated with the user to a mobile device 10 at 362. FIG. 13 shows a system that includes a server. In other example embodiments, steps 350, 352, 354 and 364 may be performed by mobile device 10.

The aforementioned methods can replace the need for a barcode 12 to be displayed and scanned in the process of transferring information between electronic devices. A method of extracting information from an electronically-stored barcode 12 is therefore provided which includes detecting the presence of the barcode 12 in an electronic medium; and analyzing the barcode 12 to decipher information stored in the barcode 12. The barcode 12 may contain links to information such as media content or documents. The barcode 12 may contain contact information or other information that can be deciphered and used without accessing a network. The barcode 12 may also contain a link or other instructions to obtain a larger file, application or media file from a database stored locally on the electronic device or stored on a database that can be accessed through a network.

The barcode 12 may provide instructions to the mobile device 10 that may be immediately implemented or may be implemented after input from the user. The information contained within the barcode 12 may also be deciphered by a server and delivered to a mobile device 10. The server may also decipher the information contained within the barcode 12 to obtain a file or an application then distribute the file or application to one or more mobile devices. The server may also decipher the information contained within the barcode 12 linked to a set of computer executable instructions and perform these instructions or send these instructions to a mobile device 10 to be performed.

The steps or operations in the flow diagrams described herein are for illustrative purposes only. There may be many variations to these steps or operations without departing from the principles discussed herein. For instance, the steps may be performed in a differing order, or steps may be added, deleted, or modified.

It can also be appreciated that the displays or screens described herein are just for example. There may be many variations to the configuration and arrangement of information and user interface controls without departing from the scope of the above principles. For instance, the information and the user interface controls may be in a differing order, or may be added, deleted, or modified.

Although the above has been described with reference to certain specific example embodiments, various modifications thereof will be apparent to those skilled in the art without departing from the scope of the claims appended hereto.

1. A method of processing a barcode, comprising:
detecting the barcode in an electronic data communication; and
analyzing the barcode in the electronic data communication, without imaging the barcode, to decode information encoded in the barcode.

2. The method according to claim 1, wherein the analyzing comprises obtaining computer executable instructions from the information encoded in the barcode.

3. The method according to claim 1, further comprising determining if a detected barcode should be analyzed.

4. The method according to claim 1, wherein an electronic device decodes the information encoded in the barcode.

5. The method according to claim 4, further comprising using the information to obtain computer executable instructions from a database.

6. The method according to claim 5, wherein the database is accessed over a network connectable to the electronic device.

7. The method according to claim 4 further comprising the electronic device executing computer executable instructions according to the decoded information.

8. The method according to claim 1, wherein a server decodes the information encoded in the barcode.

9. The method according to claim 8, further comprising the server transmitting the decoded information to at least one electronic device.

10. The method according to claim 9, further comprising using the information to obtain computer executable instructions from a database.

11. The method according to claim 10, wherein the database is accessed over a network connectable to the server.

12. The method according to claim 8, further comprising the server executing computer executable instructions according to the decoded information.

13. A computer readable medium comprising computer executable instructions for performing the method according to claim 1.

14. An electronic device comprising a processor, at least one input mechanism, and memory, the memory comprising computer executable instructions for performing the method according to claim 1.

15. A server comprising a processor, communication module, and memory, the memory comprising computer executable instructions for performing the method according to claim 1.
